(19) United States
(12) Patent Application Publication
(10) Pub. No.: US 2008/0210524 A1
(43) Pub. Date: Sep. 4, 2008

(54) Device and Method for Dispensing Fibres

(75) Inventor: Rikard Engblom, Simlangsdalen (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INCITE AB, Simlangsdalen (SE)

(21) Appl. No.: 12/089,916

(22) PCT Filed: May 11, 2006
(86) PCT No.: PCT/SE06/00554

§ 371 Date: Apr. 11, 2008

(30) Foreign Application Priority Data
Oct. 21, 2005 (SE) 0502337-9

(51) Int. Cl. B65G 27/02

(52) U.S. Cl. 198/757

(57) ABSTRACT

A device (10) and a method for dispensing fibres into concrete or similar material comprises a container (11) with an essential cylindrical shape. The container (11) has a bottom (13), an inner side (14) having a height (15) and a spiral path (12) arranged to the inner side (14). A first end of the spiral path (12) is arranged close to the bottom (13). The spiral path (12) has a width (18) that increases with the height (15) from the bottom (13) to the top of the container (11). The angle of inclination for the spiral path (12) decreases with the height (15) from the bottom (13) to the top of the container (11). The method comprises supplying the fibres into the container (11), vibrating the container (11) for feeding the fibres along the spiral path (12) and feeding the fibres continuously from the device (10) to the concrete.

### TECHNICAL FIELD

The present invention relates to a device and a method for dispensing fibres, and especially a device for dispensing reinforcing fibres into concrete or similar materials.

### BACKGROUND OF THE INVENTION

By adding reinforcing fibres to concrete, mortar or similar materials certain desirable properties of those materials are obtained. For example, the presence of fibres may improve the impact resistance, the strength and the ductility of the material. For the production of fibre concrete or a material that is reinforced with fibres, such as fibres made of plastic, carbon, steel or glass, it is important to supply the desired amount of reinforcing fibres to the mixture of components of concrete to get the desired properties of the final material. The supply of a proper amount of reinforcing fibres may be difficult, and complicated dosing or weighing devices are often used. The supply of fibres to the concrete should be continuous, i.e. the feeding of fibres from a bulk of fibres should be performed in a smooth way to avoid the problem of fibre balling or pressing fibres together into lumps.

Currently used equipment for dispensing fibres into concrete, mortar or similar materials comprises a container of cylindrical shape which is fixedly mounted on a solid base, for example a cast steel plate or a concrete floor, with dampers arranged between the base and the container. A spiral path having a constant width, for example of 200 mm, is attached to the inner side of the container. One end of the spiral path is fixed near the bottom of the container and the other end adjacent the top of the container, thus the spiral path forms several loops with a constant angle of inclination. The latter end communicates with a transfer or conveyer belt or a groove for transportation of fibres to a concrete mixer. Inside the container, on the bottom and centrally arranged thereof, there is arranged a cone having its peak directed upwardly. Vibratory engines are fixedly attached to the bottom of the container for vibrating or shaking the container. The function of the cone is to separate and distribute the fibres when added from the top of the container, for example from a large bag or a cartoon. At production of fibre concrete, fibres are supplied to the container from the top thereof, and the vibratory engines are activated for feeding the fibres upwardly along the spiral path and further on the conveyer belt for being dispensed into the concrete mixer. Often a weighing or dosing device is arranged to check that a proper amount of fibres are added to the concrete.

Such currently used equipments for fibre dosing suffer from several disadvantages. One drawback is that the fibres sometimes get stuck to the outer edge of the spiral path, i.e. against the inner side of the container, hence forming inhomogeneous lumps of fibres. Another drawback is that those lumps of fibres are packed together at feeding upwardly along the spiral path forming fibre balls, instead of being desirable less packed and loose. Thus, large friction is built into the construction of the equipment, which is yet another drawback requiring strong and consequently heavy vibratory engines to overcome the friction forces at the feeding of the fibres along the spiral path. Therefore, extreme solid bases or foundations are needed to carry and support the equipments.

### SUMMARY OF THE INVENTION

An object of the present invention is to eliminate the drawbacks mentioned above, which is achieved by assigning to the device the characteristics according to claim 1.

A further object of the invention is to provide a method for dispensing reinforcing fibres into concrete or similar materials.

According to one aspect of the invention, there is provided a device for dispensing fibres into concrete or similar materials comprising a container with an essential cylindrical shape having a bottom, an inner side having a height and a spiral path arranged to the inner side, wherein a first end of the spiral path is arranged close to the bottom of the container. The spiral path has a width that increases with the height from the bottom to the top of the container. The angle of inclination for the spiral path decreases with the height from the bottom to the top of the container. The spiral path has a perpendicular and upwardly directed edge along its length, and is made of a steel plate.

The device comprises a dispensing member arranged for receiving the fibres from the spiral path. The bottom of the container is arranged as an upwardly directed cone. Vibratory engines are arranged, such as to the bottom of the container on its external side.

According to another aspect of the invention, there is provided a method for dispensing fibres into concrete or similar materials comprising the steps of providing a device including a spiral path, wherein the spiral path has an increasing width and a decreasing angle of inclination from the bottom to the top of the container for eliminating fibre balling and friction; supplying the fibres into the container; vibrating the container for feeding the fibres along the spiral path; and feeding the fibres continuously from the device to the concrete material.

### BRIEF DESCRIPTION OF THE DRAWINGS

Further objects, features and advantages of the invention will appear from the detailed description of embodiments of the invention given below with reference to the drawings, in which:

FIG. 1 is a schematic, perspective view of a device according to a first embodiment of the invention,

FIG. 2 is a schematic top view of the device according to FIG. 1,

FIG. 3 is a schematic cross section view of the device according to FIG. 2, and

FIG. 4 is a diagram showing a graph of the angle of inclination for a spiral path of the device.

Same reference numerals have been used to indicate the same parts in the figures to increase the readability of the description and for the sake of clarity.

### DESCRIPTION OF EMBODIMENTS OF THE INVENTION

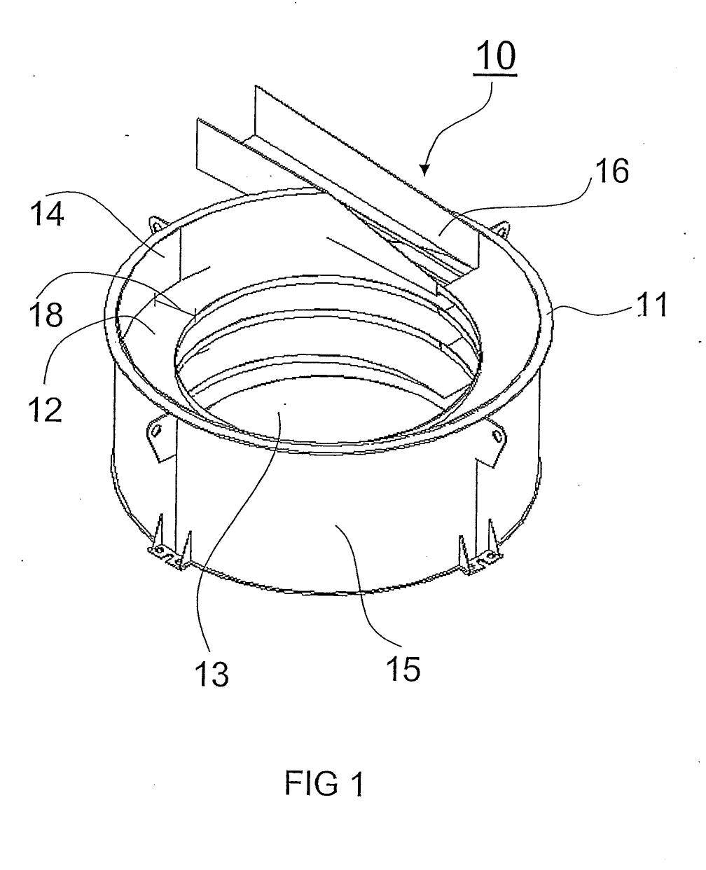

The embodiment shown in FIG. 1 relates to a fiber dispenser for feeding fibres intended to be added to concrete or similar material. The fibres could be any type of fibres commonly used within the field of fibre concrete, and may be selected from the broad class of commercially available thermoplastic polymers and copolymers or other synthetic fibres (e.g. made of polypropylene), as well as steel fibres, glass fibres, carbon fibres, and cellulose fibres. The purpose of the fibres is to improve the properties of the curing material. The expression fibre concrete is intended to include all materials provided with reinforcing fibres, such as concrete and mortar, also including fibre reinforced composite materials, such as plastic materials (PUR, PVC, PC, PA, PS, ABS, PE, PP, UP, etc.).

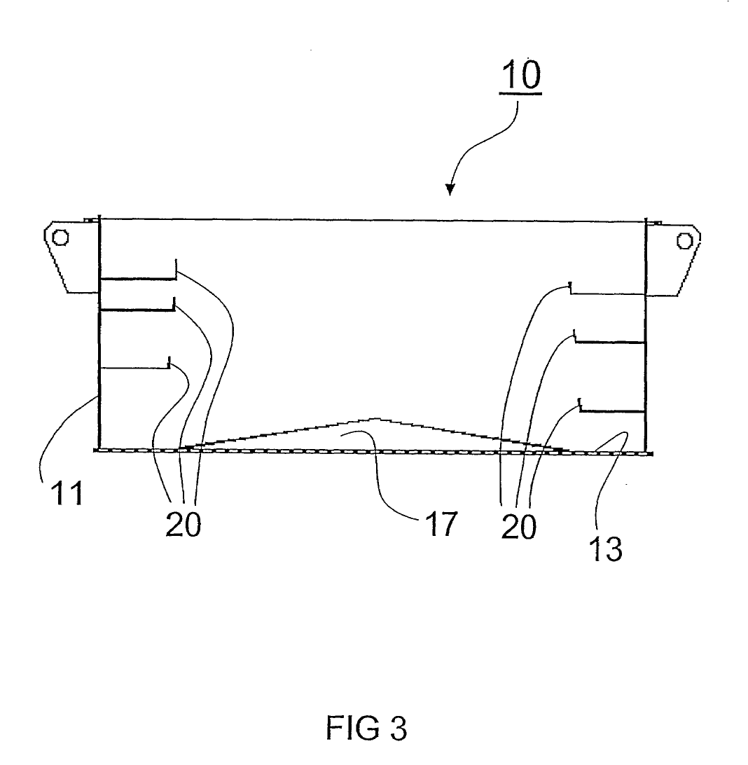

FIG. 1 discloses a device 10 for dispensing reinforcing fibres into concrete or a similar material. The device 10 comprises a container 11 having an essential cylindrical shape, and a spiral path 12, a bottom 13, and an inner side 14 having a height 15. The spiral path 12 is arranged to the inner side 14 with a first end arranged close to the bottom 13 of the container 11 and a second end arranged adjacent to the top of the container 11, hence forming one or more loops around the inner side 14. Furthermore, the device 10 comprises a dispensing member 16, which is arranged in communication with the second end of the spiral path 12, and an upwardly directed cone 17 mounted on the bottom 13, as seen in FIG. 3.

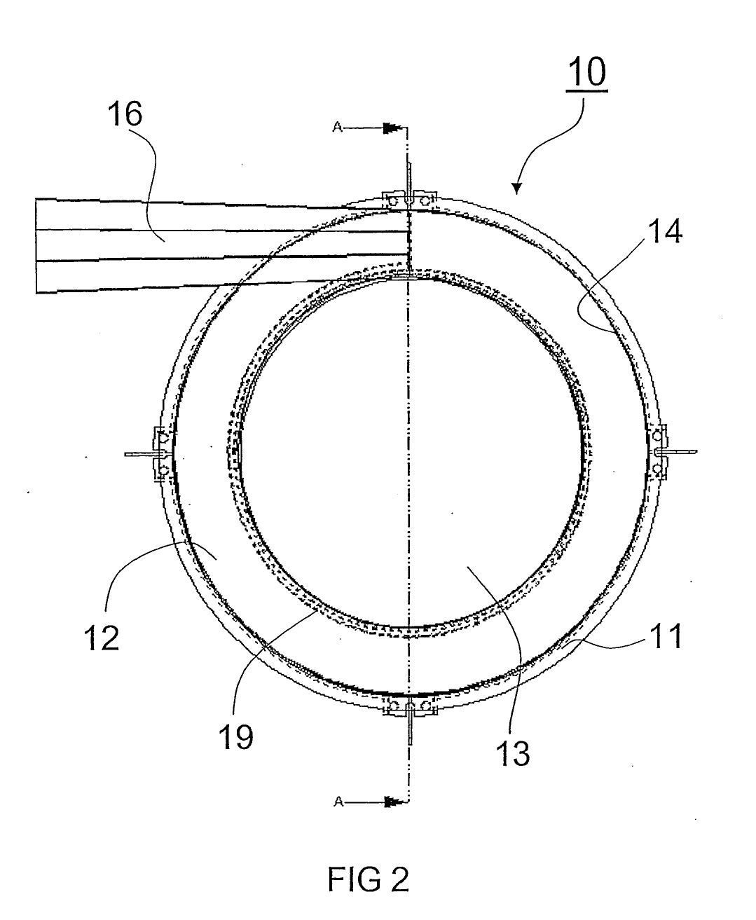

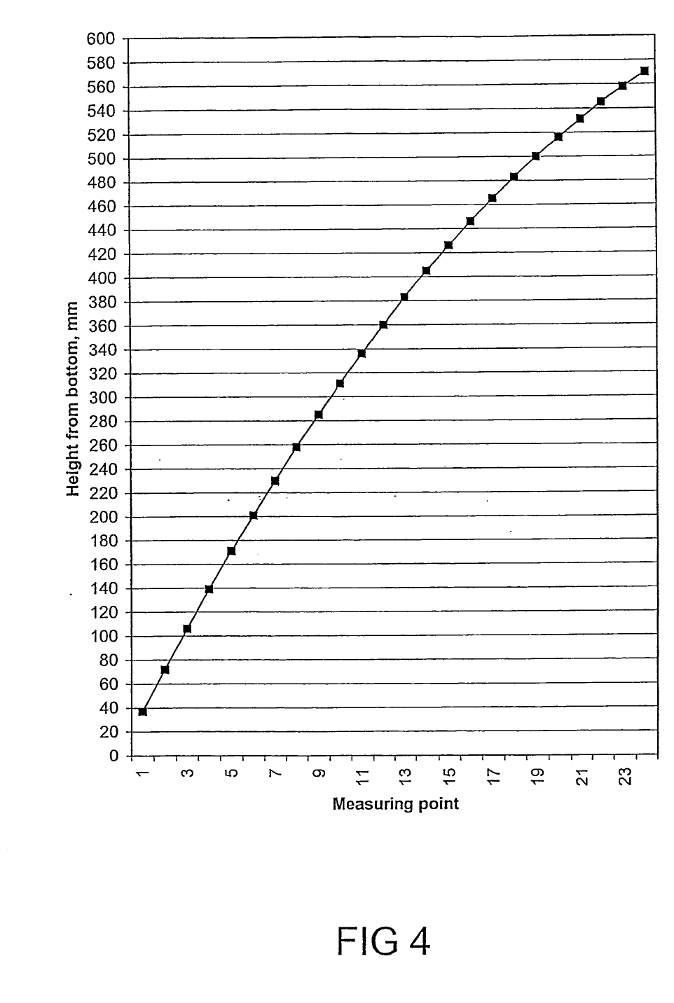

The spiral path 12 has a width 18 that increases with the height 15 from the bottom 13 to the top of the container 11, which is illustrated in FIG. 2 by the dotted, circular lines 19. For example, the width 18 at the first end can be about 200 mm while the width of the second end of the spiral path 12 is about 250 mm. The spiral path 12 is arranged so that the angle of inclination for the spiral path 12 is decreasing with the height 15, i.e. the distance between the spiral path 12 becomes smaller for each further loop, resulting in a smaller distance between loop number 2 and 3 compared to the distance between loop number 1 and 2, as is illustrated in FIG. 3. Table 1 below and FIG. 4 shows an example of the relation between the angle of inclination and the height 15 at different measuring points 1, 2, 3 . . . 24. In this case, the spiral path 12 has more than three loops, but less than four loops. In general, the number of loops can be any number.

The spiral path 12 can be made of steel, and has a perpendicular and upwardly directed edge 20 along its length, which preferably is made integrally with the spiral path 12.

TABLE 1
Angle of inclination for a spiral path

| Measuring | Angle | Height | Loop |
|---|---|---|---|
| point | (° C.) | (mm) | no. |
| 1 | 45 | 37 | 1 |
| 2 | 90 | 72 | |
| 3 | 135 | 106 | |
| 4 | 180 | 139 | |
| 5 | 225 | 171 | |
| 6 | 270 | 201 | |
| 7 | 315 | 230 | |
| 8 | 360 | 258 | |
| 9 | 485 | 285 | 2 |
| 10 | 450 | 311 | |
| 11 | 495 | 336 | |
| 12 | 540 | 360 | |
| 13 | 585 | 383 | |
| 14 | 630 | 405 | |
| 15 | 675 | 426 | |
| 16 | 720 | 446 | |
| 17 | 765 | 465 | 3 |
| 18 | 810 | 483 | |
| 19 | 855 | 500 | |
| 20 | 900 | 516 | |
| 21 | 945 | 531 | |
| 22 | 990 | 545 | |
| 23 | 1035 | 558 | |
| 24 | 1080 | 570 | |

A method for dispensing fibres into concrete or similar materials will now be described. The above-described device 10 is a portion of a dispensing apparatus. Vibratory engines, not shown, are fixed to the bottom 13 of the container 11, dampers are provided, and the device 10 is firmly attached to a base or a foundation. Initially, fibres are supplied, e.g. from a big bag or a cartoon, to the centre of the container 11 from the top of it. The vibratory engines are then activated for vibrating the container 11, for feeding the fibres upwardly along the spiral path 12. The vibration is an oscillating movement that known per se, which will move the fibres upwardly on the spiral path 12. The upwardly directed cone 20 will contribute to an even and a smooth feeding from the start. At the second end of the spiral path 12, the dispensing member 16 is receiving the fibres and is conveying them further to a conveyer or transport belt for dispensing into a concrete mixer containing the components of a concrete material.

To summarize, the device 10 has the following main advantages for decreasing the friction between fibres and the container 11 compared to currently used design.

The successive broadening of the width 18 of the spiral path 12 with the angle of inclination makes it easier to move the fibres along the spiral path 12 by means of the vibration motion caused by the vibratory engines. This is because the area for the fibres increases as the fibres move upwards along the spiral path.

Furthermore, the edge of the spiral path forms an inversed cone due to the fact that the spiral path 12 gets broader and broader in the direction upwards. When a big bag of fibres is emptied into the container 11, an angle of clearance is formed by the edge of the spiral path and downwards against the bottom 13. Thus, the fibres will not wedge one self in against the inner side 14, but will reach the bottom 13 without problem. This is important, since the feeding of fibres starts at the first end of the spiral path 12 close to the bottom 13.

By providing a regressive inclination, i.e. the angle of inclination of the spiral path in relation to the horizontal, becomes successively smaller, as shown in FIG. 4, the fibres will be separated from each other, due to that the feeding rate increases along the spiral path 12 at a flattened angle of inclination, which fact contributes to the elimination of the problem of fibre balling into the concrete.

Finally, since the friction is reduced, much less powerful vibratory engines have to be used, and thus the requirement for an extreme solid base or foundation is eliminated, which all in all contribute to less cost.

In the claims, the term “comprises/comprising” does not exclude the presence of other elements or steps. Furthermore, although individually listed, a plurality of means, elements or method steps may be implemented. Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way. The invention is only limited by the appended patent claims.

1. A device for dispensing fibres into concrete or similar materials comprising a container with an essential cylindrical shape having a bottom, an inner side having a height, and a spiral path arranged adjacent the inner side, wherein a first end of the spiral path is arranged closed to the bottom of the container, characterized in that the spiral path has a width, which increases with the height from the bottom to the top of the container.

2. A device according to claim 1, wherein the angle of inclination relative to the horizontal for the spiral path decreases with the height from the bottom to the top of the container.

3. A device according to claim 1, wherein the spiral path has a perpendicular and upwardly directed edge along its length.

4. A device according to claim 1, wherein the device comprises a dispensing member arranged for receiving the fibres from the spiral path.

5. A device according to claim 1, wherein the spiral path is made of a steel plate.

6. A device according to claim 1, wherein the device comprises an upwardly directed cone at or adjacent the bottom of the container.

7. A device according to claim 1, wherein vibratory engines are arranged to the bottom of the container.

8. A method for dispensing fibres into concrete or similar materials comprising the steps of providing a device comprising a spiral path, supplying the fibres into the container, vibrating the container for feeding the fibres along the spiral path and feeding the fibres continuously from the device to the concrete material, characterized by: providing a spiral path having an increasing width from the bottom to the top of the container and a decreasing angle of inclination from the bottom to the top of the container.
